(19) United States
(12) Patent Application Publication
(10) Pub. No.: US 2006/0221082 A1
(43) Pub. Date: Oct. 5, 2006

(54) Elapsed-time digital counter mouse pointer

(75) Inventor: Donald Owen Rifkin, Columbia, SC (US)

Correspondence Address: B. Craig Killough;Barnwell Whaley Patterson & Helms, LLC, P.O. Drawer H, Charleston, SC, 29402-0197, US

(73) Assignee: Palmetto GBA, LLC

(21) Appl. No.: 11/337,160

(22) Filed: Jan. 20, 2006

Related U.S. Application Data
(60) Provisional application No. 60/666,404, filed on Mar. 30, 2005.

(51) Int. Cl. G06T 15/70

(52) U.S. Cl. 345/473

(57) ABSTRACT

A method of indicating an elapsed amount of time related to the functioning of a computer system, generally comprising the steps of indicating the number of time increments (such as seconds) in a numeric digital display, and changing color at intervals.

Applicant claims the benefit of U.S. Provisional Application Ser. No. 60/666,404 filed Mar. 30, 2005.

### FIELD OF THE INVENTION

The present invention generally relates to computer systems, and more particularly to an animated cursor pointer used in a graphical user interface.

### BACKGROUND OF THE INVENTION

Conventional computer operating systems provide graphical user interfaces (GUIs) which allow a pointing device, such as a mouse, to manipulate a visual image on the display device, such as a flat panel display or monitor. The visual image may also be animated by the presentation of a series of images (typically stored within a single file). The pointer is used to communicate with the operating system, and for the operating system to communicate with the user its readiness or the status of tasks.

### SUMMARY OF THE INVENTION

The present invention is a method of indicating an elapsed amount of time related to the functioning of a computer system, generally comprising the steps of indicating the number of time increments (such as seconds) in a numeric digital display, and changing color at intervals, and included in the display of a visual pointer.

### DESCRIPTION OF THE FIGURES

FIGS. 1-2e comprise a flow chart describing the steps of using a preferred embodiment of the invention.

FIG. 3 demonstrates progressive digital displays associated with the pointer.

FIG. 4 demonstrates an image that is associated with the digital display to provide the pointer of a preferred embodiment.

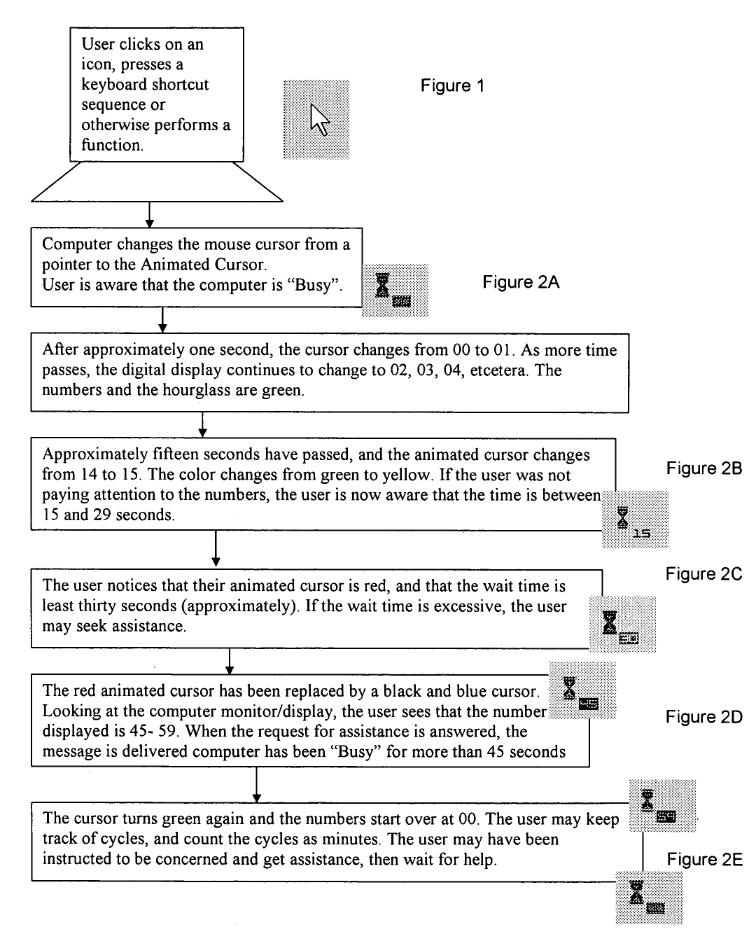

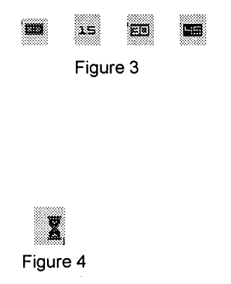

### DESCRIPTION OF THE PREFERRED EMBODIMENT

The present invention is directed to a method of providing a digital numeric counter, and indicating the elapsed time that a task has been running in a computer system as displayed within an animated cursor. In one embodiment, the digital numeric counter increments every second, from 00 to 59 seconds, then starts its cycle again at 00. The animated cursor also includes a figure, which may be an hourglass, that changes color periodically. For example, every fifteen seconds, the figure changes color, such as by starting with green, changing to yellow, then red, and finally to black-and-blue. After one minute has elapsed, the cycle repeats. The numeric counter's background may also change color every fifteen seconds and may start with green, change to yellow, then red, and finally to black-and-blue.

In a preferred embodiment, the animated cursor is a series of sixty (60) images displayed in a defined, repeating sequence. The images may have an icon associated, such as a representation of an hourglass, to convey to the viewer that the computer is busy. The images may also include a two-digit digital number that increments to indicate the passing of time and allow the user to note measurement. The images may also incorporate an analog display to indicate major gradations in the sequence.

The computer user is informed by a digital timer that is counting how long the computer has been keeping the user waiting before the user can proceed to their next task. The user is also given visual wait time information as the timer changes color, such as from green to yellow to red (and then black and blue) as the waiting time is extended. The color changes are expected to give the computer user the impression that waiting a short time is acceptable (green), but that longer delays are a cause for concern (for example, yellow to red to black and blue).

The image may depict an hourglass, clock or other timer. The computer user will recognize the image as indicative of a situation in which the user is waiting for the computer to complete a process. When a process completes, the computer will change the image to indicate that the user may select the next activity.

The digital number that is associated with the image may begin at “00” (zero zero) and increase in increments by 1 until it reaches “59”. At that point the sequence may begin a new cycle at “00” (zero zero) again, and the cycle is repeated as necessary. The digital number could begin at any selected number and increase to any desired number before recycling.

The animated cursor changes colors as it cycles. In a preferred embodiment, the animated cursor uses four colors, loosely based on traffic signal coloring. From 00 to 14 (first series of 15 images), the hourglass and digits may be green. From 15 to 29 (second series of 15 images), the hourglass and digits may be yellow. From 30 to 44 (third series of 15 images), the hourglass and digits may be red, and from 45 to 59 (fourth and last series of 15 images before the first series of images are used again), the hourglass and digits may be black and blue.

The cursor form of the invention is made visible by placing its file on the computer and configuring the computer to use it as the cursor displayed when the operating system is in the appropriate state. Placing the file on the computer can be carried out by several means including, but not limited to, copying it from a diskette, CD, or DVD, downloading it from a server, or receiving the file attached to e-mail. Configuring the computer to use a non-standard cursor includes, but is not limited to, using the Control Panel, or modification of the Registry.

The file for the invention is comprised of a series of images and instructions. The instructions control the elapsed time between images. In the preferred embodiment, the file is named NGD60BUSY2.ANI. The preferred embodiment is recognized by a Microsoft Windows operating system environment that utilizes files that end with “.ANI” as animated cursors. The location of the file in the preferred embodiment is in the same location as other “.ANI” files and “.CUR” (cursor) files provided with the operating system.

The animated cursor is displayed when the operating system is in the “Busy” state. This state is when the computer user should not attempt to do any further work on the computer, because the computer is waiting on a process to complete. When the computer is not in the Busy state, it uses other cursors as defined for the mouse in the Control Panel's Mouse applet.

When the user performs a function or requests a function of the computer (a “task”), there may be elapsed time before the computer is able to complete the task. While the user is waiting, the animated cursor replaces the cursor used to denote that the computer is available (the system-ready cursor is typically a plain arrow pointing to the upper left).

In one embodiment, the animated cursor is displayed starting with its first image, which includes the digits 00. It is colored green. As time passes and the computer has not completed the task, the animated cursor continues to cycle through its images, giving the impression of a digital clock cycling through 60 seconds. The series of images includes the color changes as described previously: Green to Yellow to Red to Black-and-Blue, then starts over with Green again.

When the computer completes the task, it changes the cursor based on the changed state of readiness. Because the computer is no longer “Busy”, the animated cursor is no longer displayed. A different cursor may be displayed as defined in the Control Panel's Mouse applet.

The resulting invention is a method of indicating an elapsed amount of time related to the functioning of a computer system, generally comprising the steps of indicating the number of time increments (such as seconds) in a numeric digital display and changing color at intervals and included in the display of a visual pointer. Other visual pointers (such as a combined arrowhead and hourglass) can be displayed during other functions or states of the computer system. The elapsed-time pointer can be utilized during task execution to quantify the time that has passed while the user waits to enter their next request, or it can be utilized with the wait state of the system to quantify the time that passes once the system is ready for use, until the user chooses the next task.

In another embodiment of the invention, the animated cursor periodically changes colors, but does not always have increasing or decreasing digits (numbers) that indicate seconds elapsed displayed with the pointer. The first fifteen seconds elapse without a numeric display. This initial, “safe time”, which may be presented in the color green, may not cause concern to the computer user, and the display of digits may be superfluous for the first 15 seconds. The numbers may appear, for example, beginning with 15 and continue through 59. The colors of the image, such as an hourglass, change periodically, as with the embodiments described above. The cursor may also have other selected points or sections of time when the numeric digits are not displayed. This embodiment provides the user with an additional visible element that conveys to them that the exact measurement of time that has elapsed is not as critical at that time.

### Description of Creation of an Embodiment

A preferred embodiment of the invention is created by first designing the images: pointer, digital numbers, and background for the numbers, using a grid sized to match the pixel dimensions of a mouse cursor as defined for the desired operating system. The image may use 32 pixels wide by 32 pixels high. The next step is to use software designed for the creation of animated cursors to convert the designs into an animated cursor. A typical software package presents a window with tools and functions similar to other drawing programs such as Microsoft Paint or Paintbrush. The significant differences include the ability to create a file containing multiple images, to include timing information, and to save the file with a file extension of “ANI”.

The images are drawn on the screen of the animated cursor editing software using the tools provided. Colors are selected as desired. The number of images, time intervals and colors are defined by the designer. In the preferred embodiment, 60 images were designed and created. The time delay between the display of the images is selected before the file is saved. In the preferred embodiment the time between images was adjusted such that the images were displayed one second apart.

The file is named by the user, with the “.ANI” extension chosen by the software. In one embodiment, the file is named NGD60busy2.

What is claimed is:

1. A method of presenting an elapsed time display, comprising the steps of: presenting an icon on a visual display, wherein presentation of said icon is initiated by initiating a task by a computer that communicates with said visual display, and wherein said icon is manipulated in two dimensions on said visual display as a pointer for said visual display;
presenting a first color and a time indication in association with said icon, sequentially changing said time indication as a function of elapsed time of completion of said task by said computer;
changing said first color of said icon to a second color of said icon at an end of a predetermined time interval;
changing said second color of said icon to a third color of said icon at an end of a second predetermined time interval; and
terminating presentation of said time indication upon completion of said task.

2. A method of presenting an elapsed time display as described in claim 1, wherein manipulation of said icon in two dimensions is controlled by a mouse, and wherein said mouse communicates with said computer to initiate said task, and said mouse communicates with said computer to initiate said icon.

3. A method of presenting an elapsed-time display as described in claim 1, further comprising the step of terminating a display of one of said first color, said second color and said third color when said task is completed.

4. A method of presenting an elapsed-time display as described in claim 1, further comprising the step of terminating a display of said icon when said task is completed.

5. A method of presenting an elapsed-time display as described in claim 1 wherein said first color is green, said second color is yellow, and said third color is red.

6. A method of presenting an elapsed-time display as described in claim 1, further comprising the step of changing said third color of said icon to a fourth color of said icon at an end of a third predetermined time interval.

7. A method of presenting an elapsed-time display as described in claim 1 wherein said time indication is in one second intervals.

8. A method of presenting an elapsed time display as described in claim 1, wherein said time indication is reset to zero, and said first color is presented again if said task is not completed by an end of a predetermined time cycle.

9. A method of presenting an elapsed-time display as described in claim 1, wherein said time indication is a series of images presented by said computer on said visual display at predetermined intervals.
